(19) United States
(12) Patent Application Publication
(10) Pub. No.: US 2020/0109274 A1
(43) Pub. Date: Apr. 9, 2020

(54) Thermoplastic Fluororesin Composition, Electric Wire and Cable

(71) Applicant: Hitachi Metals, Ltd., Tokyo (JP)

(72) Inventors: lkuo SEKI, Tokyo (JP); Takashi AOYAMA, Tokyo (JP); Tomiya ABE, Tokyo (JP)

(21) Appl. No.: 16/387,903

(22) Filed: Apr. 18, 2019

(30) Foreign Application Priority Data
May 14, 2018 (JP) 2018-093360

(51) Int. Cl. C08L 27/20; C08L 27/16; C08L 27/12; H01B 3/44; H01B 7/02

(52) U.S. Cl. CPC C08L 27/20; C08L 27/16; C08L 27/12; H01B 3/445; C08L 2203/202; C08L 2205/03; C08L 2205/025; C08L 2205/035; H01B 7/02

(57) ABSTRACT

An electric wire uses a thermoplastic fluororesin composition as an insulating layer covering a periphery of a conductor. The thermoplastic fluororesin composition includes a fluororubber, a fluororesin and a compatibilizer. The fluororesin includes a first fluororesin constituted by perfluoroalkoxy alkane having a melting point of 280° C. or more and 290° C. or less, and the compatibilizer is a terpolymer of tetrafluoroethylene, hexafluoropropylene and vinylidene fluoride. A weight ratio (%) of the fluororubber to the fluororesin ranges from 20:80 to 60:40, and the fluororubbers are crosslinked to one another by dynamic crosslinking.

### CROSS-REFERENCE TO RELATED APPLICATION

The present application claims priority from Japanese Patent Application No. 2018-93360 filed on May 14, 2018, the content of which is hereby incorporated by reference into this application.

### TECHNICAL FIELD OF THE INVENTION

The present invention relates to a thermoplastic fluororesin composition, an electric wire and a cable.

### BACKGROUND OF THE INVENTION

An electric wire has a conductor, and an insulating layer provided over a periphery of the conductor and serving as a covering material. A cable comprises the electric wire, and a sheath layer (outer sheath layer) provided over a periphery of the electric wire and serving as a covering material. The sheath layer is provided over a periphery of the insulating layer.

The covering material such as the insulating layer of the electric wire or the sheath layer of the cable is constituted by an electrically insulating material mainly made of an elastomer or resin. Examples of the electrically insulating material include a thermoplastic elastomer (TPE). A particular example of the thermoplastic elastomer having excellent heat resistance and chemical resistance is a thermoplastic fluororesin composition.

Fluororubber which is one example of the thermoplastic fluororesin composition has properties such as excellent heat resistance and chemical resistance, and therefore is used in many applications in the industrial field, automotive field, semiconductor field and the like. In addition, fluororesin which is another example of the thermoplastic fluororesin composition has properties such as excellent slidability, heat resistance and chemical resistance, and therefore is used in many applications in the industrial field, automotive field, semiconductor field and the like.

In order to further improve heat resistance of the fluororubber or to introduce flexibility to the fluororesin, research has been conducted on polymer alloys of the fluororubber and the fluororesin. However, since affinity between the fluororubber and the fluororesin is low, simply melt-kneading the fluororubber and the fluororesin would cause poor dispersion, resulting in problems such as delamination and reduction in strength.

Thus, for example, International Publication No. WO2006/057332 (Patent Document 1) discloses a technique in which a thermoplastic fluororesin composition is obtained by adding a specific compatibilizer as the compatibilizer, in addition to the fluororubber and the fluororesin.

### SUMMARY OF THE INVENTION

However, studies conducted by the present inventors have revealed that, when perfluoroalkoxy alkane (PFA) is adopted as the fluororesin constituting the above-described thermoplastic fluororesin composition, there are cases where it is not possible to obtain tensile properties and heat resistance that are sufficient for the covering material such as the outer sheath layer of the cable or the insulating layer of the electric wire.

Specifically, in the thermoplastic fluororesin composition in which perfluoroalkoxy alkane is adopted as the fluororesin, it was found that tensile strength at break is less than 10 MPa and that elongation is less than 300%. Further, in the thermoplastic fluororesin composition in which perfluoroalkoxy alkane is adopted as the fluororesin, it was also found that a continuous operation temperature is reduced to approximately 200° C.

The present invention has been made in view of the problems described above, and its object is to provide a thermoplastic fluororesin composition having excellent tensile properties and heat resistance, and an electric wire and a cable that utilizes this thermoplastic fluororesin composition.

The following is a brief overview of a representative embodiment disclosed in the present application.

[1] A thermoplastic fluororesin composition includes a fluororubber, a fluororesin and a compatibilizer, the fluororesin includes a first fluororesin constituted by perfluoroalkoxy alkane having a melting point of 280° C. or more and 290° C. or less, and the compatibilizer is a terpolymer of tetrafluoroethylene, hexafluoropropylene and vinylidene fluoride. In the thermoplastic fluororesin composition, a weight ratio (%) of the fluororubber to the fluororesin ranges from 20:80 to 60:40, and the fluororubbers are crosslinked to one another by dynamic crosslinking.

[2] In the thermoplastic fluororesin composition according to [1], the compatibilizer is the terpolymer of tetrafluoroethylene, hexafluoropropylene and vinylidene fluoride in which a molar ratio of tetrafluoroethylene units to hexafluoropropylene units to vinylidene fluoride units ranges from 30:15:10 to 70:40:50.

[3] In the thermoplastic fluororesin composition according to [1], the fluororesin further includes a second fluororesin having a melting point of 275° C. or less.

[4] An electric wire comprises an insulating layer made of the thermoplastic fluororesin composition according to at least one of [1] to [3].

[5] A cable comprises a sheath layer made of the thermoplastic fluororesin composition according to at least one of [1] to [3].

According to the present invention, it is possible to provide a thermoplastic fluororesin composition having excellent tensile properties, and an electric wire and cable that utilizes this thermoplastic fluororesin composition.

### BRIEF DESCRIPTIONS OF THE DRAWINGS

FIG. 1 is a cross-sectional view showing a structure of an electric wire of the present invention;

FIG. 2 is a cross-sectional view showing a structure of a cable of the present invention;

FIGS. 3A to 3H show cross-sectional images of extruded capillary strand samples of Examples 1 to 8 viewed from a scanning electron microscope;

FIGS. 4A to 4F show cross-sectional images of extruded capillary strand samples of Examples 9 to 14 viewed from the scanning electron microscope.

### DESCRIPTIONS OF THE PREFERRED EMBODIMENTS

(Studied Items)

Before describing the embodiments, items studied by the present inventors will be described.

Perfluoroalkoxy alkane (PFA) which is one of the fluororesins has a high melting point similar to other fluororesins and is a fluororesin that can be melt-processed. Thus, when perfluoroalkoxy alkane is adopted as the fluororesin in the thermoplastic fluororesin composition constituted by a fluororubber, a fluororesin and a compatibilizer, the thermoplastic fluororesin composition is expected to have excellent tensile properties and heat resistance.

However, as described above, the present inventors have found that there are cases where it is not possible to obtain sufficient tensile properties and heat resistance in the thermoplastic fluororesin composition in which perfluoroalkoxy alkane is adopted as the fluororesin. The present inventors have analyzed the thermoplastic fluororesin composition that failed to obtain sufficient tensile properties and heat resistance, and have found that such a thermoplastic fluororesin composition has a phase structure in which the fluororubber is in a continuous phase (sea phase, matrix) and the fluororesin is in a dispersed phase (island phase, domain), or has a phase structure in which the fluororubber and the fluororesin are both in the continuous phase (sea phase).

Therefore, in order to obtain sufficient tensile properties and heat resistance for the covering material such as the outer sheath layer of the cable or the insulating layer of the electric wire, the thermoplastic fluororesin composition in which perfluoroalkoxy alkane is adopted as the fluororesin needs to have a phase structure of a so-called “sea-island structure” in which, unlike the above-described case, the fluororubber is in the dispersed phase (island phase) and the fluororesin is in the continuous phase (sea phase). This is because the elastic fluororubber in the dispersed phase (island phase) being present in the composition allows elasticity to be obtained at room temperature for the entire composition. This is also because the thermoplastic fluororesin in the continuous phase (sea phase) being present in the composition allows the continuous phase (sea phase) to flow at a high temperature so as to cause plastic deformation.

As a result, the thermoplastic fluororesin composition has tensile properties that are sufficient for the covering material of the cable or the electric wire, whereby the cable and the electric wire can be easily manufactured by using a molding device similar to that used for thermoplastic plastics.

Here, in order to obtain the above-described sea-island structure, that is, the phase structure in which the fluororubber is in the dispersed phase (island phase) and the fluororesin is in the continuous phase (sea phase), the fluororubbers need to be dynamically crosslinked (dynamically vulcanized) with one another in the thermoplastic fluororesin composition. Dynamic crosslinking is a crosslinking method in which a crosslinking reaction is performed while each of the raw materials is kneaded. Dynamic crosslinking allows the fluororubbers to be crosslinked to one another and cured such that the crosslinked fluororubber is completely and uniformly dispersed as the dispersed phase (island phase) in the continuous phase (sea phase) of the fluororesin.

As described above, dynamic crosslinking is performed in a state where each of the raw materials is kneaded, whereby it is necessary to perform dynamic crosslinking at a temperature at or above a melting point of each of the raw materials. Among the raw materials of the thermoplastic fluororesin composition, fluororesin has the highest melting point. As described below, perfluoroalkoxy alkane typically used has a substituent group that is of a perfluoroethyl group, and has a melting point of 305° C. Here, when the temperature at which dynamic crosslinking is performed is substantially the same as the melting point of the fluororesin, there may be a case where kneading of each of the raw materials is prevented from proceeding. Thus, considering that the kneading is to be sufficiently performed and that the reaction is to be sufficiently accelerated, the temperature (that is, 325° C. to 345° C.) suitable for dynamic crosslinking is 20° C. to 40° C. higher than the melting point of the fluororesin. However, the typical temperature at which the fluororubber begins to thermally decompose ranges from 310° C. to 320° C. Thus, when dynamic crosslinking was performed at 335° C. by a polyol crosslinking method which is one type of crosslinking method, the crosslinking reaction proceeded rapidly, thereby causing the fluororubber to thermally decompose, resulting in a problem in which lumps easily form at the time of extrusion (Comparative Example 2 described below).

From the above, in the thermoplastic fluororesin composition in which perfluoroalkoxy alkane is used as the fluororesin, it is desired that the raw materials and processes thereof are devised so as to suppress thermal decomposition of the fluororubber and promote dynamic crosslinking. It is therefore desired that the phase structure in which the fluororubber is in the dispersed phase (island phase) and the fluororesin is in the continuous phase (sea phase) is formed in the thermoplastic fluororesin composition in which perfluoroalkoxy alkane is adopted as the fluororesin.

### Embodiment

(1) Thermoplastic Fluororesin Composition

The thermoplastic fluororesin composition according to one embodiment of the present invention includes a fluororubber (A), a fluororesin (B), and a compatibilizer (C). Further, the fluororubbers (A) in the thermoplastic fluororesin composition are crosslinked to one another by dynamic crosslinking. The fluororesin (B) is constituted by perfluoroalkoxy alkane having a melting point of 290° C. or less. The compatibilizer (C) is a terpolymer of tetrafluoroethylene, hexafluoropropylene and vinylidene fluoride in which a molar ratio of tetrafluoroethylene units to hexafluoropropylene units to vinylidene fluoride units ranges from 30:15:10 to 70:40:50. As a result, the compatibilizer (C) has a specific gravity of approximately 1.90 or more. A weight ratio (%) of the fluororubber (A) to the fluororesin (B) ranges from 20:80 to 60:40. Further, a blending amount of the compatibilizer (C) ranges from 1 to 30 parts by weight with respect to 100 parts by weight of a total between the fluororubber (A) and the fluororesin (B).

The fluororesin (B) may be of a single type of fluororesin, or may be of two or more types of fluororesins mixed together as described below. For example, it is preferable that the fluororesin (B) includes a first fluororesin (B′) having a melting point of 280° C. or more and 290° C. or less, and a second fluororesin (B″) having a melting point of 275° C. or less.

Note that, when the weight ratio (%) of the fluororesin (B) in the weight ratio of the fluororubber (A) to the fluororesin (B) is less than 40, the crosslinked fluororubber (A) and the fluororesin (B) both form the continuous phase (sea phase), or the crosslinked fluororubber (A) forms the continuous phase (sea phase) and the fluororesin (B) forms the dispersed phase (island phase) in the produced thermoplastic fluororesin composition. As a result, the produced thermoplastic fluororesin composition is poor in appearance, and tensile strength and elongation of the thermoplastic fluororesin composition is greatly reduced. In addition, the continuous operation temperature of the thermoplastic fluororesin composition is reduced to approximately 200° C. Here, the continuous operation temperature refers to a temperature in which an absolute value of elongation is reduced to 50% in a case where the composition is, for example, exposed to the atmosphere for 40,000 hours at a constant temperature.

In addition, when the weight ratio (%) of the fluororesin (B) in the weight ratio of the fluororubber (A) to the fluororesin (B) is greater than 80, that is, when the weight ratio (%) of the fluororubber (A) is less than 20, flexibility (plasticity) of the produced thermoplastic fluororesin composition is significantly reduced.

Thus, when considering tensile properties, heat resistance, flexibility and the like as a whole, it is preferable that the weight ratio (%) of the fluororubber (A) to the fluororesin (B) ranges from 20:80 to 60:40, and is more preferable that the weight ratio (%) ranges from 30:70 to 50:50.

In addition, when the blending amount of the compatibilizer (C) is less than 1 parts by weight with respect to 100 parts by weight of the total between the fluororubber (A) and the fluororesin (B), a diameter of dispersion of the crosslinked fluororubber (A) is increased, causing the produced thermoplastic fluororesin composition to be poor in extrusion appearance. In addition, the compatibilizer (C) of the present embodiment is the terpolymer of tetrafluoroethylene, hexafluoropropylene and vinylidene fluoride having a small molar ratio of vinylidene fluoride units that form double bonds (that is, can be crosslinked) by dehydrofluorination. Thus, when the blending amount of the compatibilizer (C) is greater than 30 parts by weight with respect to 100 parts by weight of the total between the fluororubber (A) and the fluororesin (B), the apparent crosslinking density in the thermoplastic fluororesin composition is reduced, whereby the crosslinked fluororubbers (A) are likely to agglomerate at the time of extrusion, resulting in a problem in which lumps are formed. Thus, it is preferable that the blending amount of the compatibilizer (C) ranges from 1 to 30 parts by weight, and is more preferable that the blending amount ranges from 2 to 20 parts by weight, with respect to 100 parts by weight of the total between the fluororubber (A) and the fluororesin (B).

In addition, in the produced thermoplastic fluororesin composition of the present embodiment, it is preferable that an average particle diameter of the crosslinked fluororubber (A) forming the dispersed phase (island phase) is 10 μm or less, and is more preferable that the average particle diameter is 5 μm or less. By setting the average particle diameter of the crosslinked fluororubber (A) so as to be 10 μm or less, it is possible to further improve draw-down capability, tensile properties, heat resistance and the like of the thermoplastic fluororesin composition.

<Fluororubber>

The fluororubber (A) of the present embodiment is a vinylidene fluoride-based fluororubber (FKM). More specifically, it is preferable that the fluororubber (A) is a bipolymer (such as Viton (registered trademark) A manufactured by DuPont, and DAI-EL (registered trademark) G-701 manufactured by Daikin Industries) of hexafluoropropylene (HFP) and vinylidene fluoride (VdF). Alternatively, the fluororubber may be a terpolymer (such as Viton (registered trademark) B manufactured by DuPont, and DAI-EL (registered trademark) G-551 manufactured by Daikin Industries) of tetrafluoroethylene (TFE), hexafluoropropylene (HFP) and vinylidene fluoride (VdF). The terpolymer classified as the fluororubber (A) is a terpolymer in which the molar ratio (%) of tetrafluoroethylene units to hexafluoropropylene units to vinylidene fluoride units ranges from 0.1:15:40 to 30:60:80 (specific gravity: 1.85 to 1.88), and it is preferable that terpolymer is a terpolymer in which the molar ratio of the vinylidene fluoride units having properties of the fluororubber is 50% or more.

<Fluororesin>

The fluororesin (B) of the present embodiment includes perfluoroalkoxy alkane (Chemical Formula 1) having a melting point of 280° C. or more and 290° C. or less. Perfluoroalkoxy alkane is a copolymer of perfluoroalkylvinylether and tetrafluoroethylene.

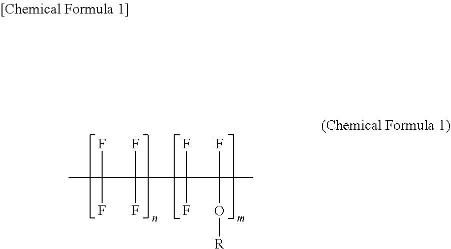

More specifically, it is preferable that the fluororesin (B) used in the first and second embodiments described below is constituted by perfluoroalkoxy alkane (melting point: 285° C.) having an alkyl group (R in Chemical Formula 1) that includes both perfluoromethyl and perfluoropropyl groups. The perfluoroalkyl group represented by the perfluoromethyl and perfluoropropyl groups is a group in which hydrogen (H) of the alkyl group has been entirely substituted with fluorine (F).

In addition, the fluororesin (B) used in a modification example of the first embodiment described below includes the first fluororesin (B′) having a melting point of 280° C. or more and 290° C. or less, and the second fluororesin (B″) having a melting point of 275° C. or less. At this time, it is preferable that the first fluororesin (B′) is constituted by perfluoroalkoxy alkane (melting point: 285° C.) having the alkyl group (R in Chemical Formula 1) that includes both the perfluoromethyl group and the perfluoropropyl group. Specifically, it is preferable that the first fluororesin (B′) is a copolymer of trifluoro (trifluoromethoxy) ethylene and 1,1,1,2,2,3,3-heptafluoro-3-[(trifluoroethenyl)oxy]propane with tetrafluoroethylene.

In addition, it is preferable that the second fluororesin (B″) is constituted by perfluoroalkoxy alkane (melting point: 270° C.) having an alkyl group (R in Chemical Formula 1) that is of the perfluoromethyl group. Specifically, it is preferable that the second fluororesin (B″) is a copolymer of trifluoro (trifluoromethoxy) ethylene and tetrafluoroethylene.

In addition, the first fluororesin (B′) used in a third embodiment described below is constituted by the fluororesin having a melting point of 275° C. or less. Further, the second fluororesin (B″) used in the third embodiment has no limitation regarding a melting point thereof. For example, it is possible to use perfluoroalkoxy alkane (melting point: 305° C.) having the alkyl group (R in Chemical Formula 1) that is of the perfluoroethyl group, or more specifically, it is possible to use a copolymer of trifluoro (trifluoroethoxy) ethylene and tetrafluoroethylene.

<Compatibilizer>

The compatibilizer (C) of the present embodiment is the terpolymer of tetrafluoroethylene (TFE), hexafluoropropylene (HFP) and vinylidene fluoride (VdF). It is preferable that the terpolymer is a terpolymer (such as THV (registered trademark) fluoroplastics manufactured by Sumitomo 3M) in which the molar ratio (%) of tetrafluoroethylene units to hexafluoropropylene units to vinylidene fluoride units ranges from 30:15:10 to 70:40:50 (specific gravity: approximately 1.90 or more). In the terpolymer, when the molar ratio of the tetrafluoroethylene units is 30% or more and the molar ratio of the vinylidene fluoride units is 50% or less, the terpolymer exhibits intermediate properties between the fluororubber and the fluororesin. The properties of the fluororesin allow the terpolymer to act as the compatibilizer (C) of the fluororubber (A) and the fluororesin (B). Further, since the terpolymer holds crystals, using the terpolymer as the compatibilizer (C) allows the thermoplastic fluororesin composition to be pelletized as in a crosslinking fluororubber masterbatch described below.

<Crosslinking Agent>

A polyol crosslinking agent (D) is used as a crosslinking agent of the present embodiment. Details of polyol crosslinking will be described below.

Examples of the polyol crosslinking agent (D) include bisphenol AF, bisphenol A, p,p′-biphenyl, 4,4′-dihydroxydiphenylmethane, hydroquinone, dihydroxybenzophenone, and alkali metal salts thereof. In the present embodiment, it is preferable that aromatic polyol, or particularly, bisphenol AF, is used from the viewpoint of heat resistance.

In a polyol crosslinking reaction, it is preferable that the crosslinking agent is used along with a crosslinking accelerator and/or a crosslinking accelerator aid described below. There is no particular limitation on the amounts of the crosslinking agent and the crosslinking accelerator (aid), and the amounts can be set to any desired amount according to an intended degree of the crosslinking, the type of the crosslinking accelerator (aid), and the like.

However, in a case where the amounts of the crosslinking agent and the crosslinking accelerator (aid) are too small, the crosslinking density is reduced, the fluororesin (B) is less likely to form the continuous phase (sea phase), and the dispersed phase (island phase) formed by the crosslinked fluororubber (A) is agglomerated at the time of extrusion, resulting in a problem in which lumps are formed. In contrast, in a case where the amounts of the crosslinking agent and the crosslinking accelerator (aid) are too large, viscosity of the produced thermoplastic fluororesin composition becomes too high as the crosslinking density of the fluororubber (A) is increased, resulting in a problem in which draw-down capability at the time of extrusion is reduced. Thus, it is preferable that 1 to 10 parts by weight of each of the crosslinking agent, the crosslinking accelerator and the crosslinking accelerator aid is added with respect to 100 parts by weight of the fluororubber (A).

<Crosslinking Accelerator>

In the present embodiment, it is preferable that organic phosphonium salts such as benzyltriphenylphosphonium chloride (BTPPC), quaternary ammonium salts such as tetrabutylammonium=chloride, 1,8-diazabicyclo[5.4.0]undec-7-ene, hexamethylenetetramine, or the like is used as the crosslinking accelerator for the polyol crosslinking reaction. Onium salts (ammonium or phosphonium salts), amine and the like act as a dehydrofluorination catalyst in the polyol crosslinking reaction.

<Crosslinking Accelerator Aid>

Hydrofluoric acid generated during the crosslinking reaction needs to be neutralized in the polyol crosslinking reaction, and thus, it is required to use an acid receiving agent (metal oxide) as one of the crosslinking accelerator aids. Examples of the acid receiving agent include magnesium oxide (MgO), calcium hydroxide (Ca(OH)₂), calcium oxide (CaO) and lead oxide (PbO). However, the acid receiving agent is not limited to these examples. In addition, a plurality of acid receiving agents may be used in combination. After the polyol crosslinking reaction, the thermoplastic fluororesin composition has an improved compression set ratio, whereby it is preferable that a highly active magnesium oxide is used as the acid receiving agent. In addition, in a case where onium salts are used as the dehydrofluorination catalyst in the polyol crosslinking reaction, calcium hydroxide also acts as a co-catalyst thereof.

In a case where magnesium oxide or calcium hydroxide is used as the crosslinking accelerator aid, it is preferable that 1 to 10 parts by weight of magnesium oxide or calcium hydroxide, or particularly, 2 to 8 parts by weight of magnesium oxide or calcium hydroxide, is used with respect to 100 parts by weight of the fluororubber (A).

<Dynamic Crosslinking>

As described above, dynamic crosslinking is a crosslinking method in which the crosslinking reaction is performed while each of the raw materials is kneaded. Specifically, in the present embodiment, the crosslinking reaction is allowed to proceed while the mixture of the fluororubber (A), the fluororesin (B) and the compatibilizer (C) is being kneaded. In this manner, the fluororubbers (A) are crosslinked to one another in the thermoplastic fluororesin composition which is the product.

When the fluororubbers (A) are crosslinked to one another in the thermoplastic fluororesin composition, the diameter of dispersion of the fluororubbers (A) is reduced, thereby allowing the fluororesin (B) to easily form the continuous phase. In such a thermoplastic fluororesin composition, lumps caused by agglomerates of the fluororubbers (A) are less likely to form at the time of extrusion, thereby providing good tensile properties and heat resistance.

In the present embodiment, the polyol crosslinking reaction is used as the dynamic crosslinking method. The polyol crosslinking reaction is a reaction in which (a) hydrogen fluoride is released from a fluororubber molecular chain with using onium salts (such as ammonium salts and phosphonium salts) as a catalyst to form double bonds (dehydrofluorination reaction), and (b) a bisphenol compound is added to two or more double bonds formed in the fluororubber molecular chain to allow crosslinking in the fluororubber molecular chain or between the fluororubber molecular chains. Adding calcium hydroxide as the co-catalyst to the onium salt at this time allows the calcium hydroxide to act as the catalyst for the dehydrofluorination reaction.

Note that a method other than the polyol crosslinking reaction can be considered for the dynamic crosslinking method. However, a polyamine crosslinking agent and a peroxide crosslinking agent among the commonly used crosslinking agents would not be applicable to the present invention since they need to be subjected to a temperature that is lower than the melting point of the fluororesin (B), whereby the mixture of the fluororubber (A), the fluororesin (B) and the compatibilizer (C) cannot be kneaded. In addition, electron beam crosslinking using an electron beam would not be applicable to the present invention since it cannot be used during kneading.

In a case where dynamic crosslinking is performed in the present embodiment, it is preferable that the crosslinking reaction is allowed to proceed after the mixture of the fluororubber (A), the fluororesin (B) and the compatibilizer (C) is kneaded to some extent. This is because, if the crosslinking reaction is allowed to proceed without the mixture of the fluororubber (A), the fluororesin (B) and the compatibilizer (C) being kneaded, crosslinking of the fluororubbers (A) proceeds before the fluororubbers (A) are sufficiently dispersed in the mixture, whereby dispersion of each of the components is likely to become uneven.

Note that the polyol crosslinking reaction is allowed to proceed when the fluororubber (A), the polyol crosslinking agent and the crosslinking accelerator (D) are present. Thus, in a case where the polyol crosslinking reaction is to be performed, all three components of the polyol crosslinking agent, the crosslinking accelerator and the crosslinking accelerator aid (D) may be added after kneading of the mixture of the fluororubber (A), the fluororesin (B) and the compatibilizer (C) is started. Alternatively, the crosslinking accelerator and/or the crosslinking accelerator aid may be added to the fluororubber (A), the fluororesin (B) and the compatibilizer (C) prior to kneading, and the polyol crosslinking agent and/or the crosslinking accelerator aid (D) may be added after the mixture is kneaded. In order to uniformly disperse each of the components and allow the polyol crosslinking reaction to proceed uniformly, it is most preferable that the crosslinking accelerator and the crosslinking accelerator aid are added to the fluororubber (A), the fluororesin (B) and the compatibilizer (C) prior to kneading, and the polyol crosslinking agent (D) is added after the mixture is kneaded.

In addition, according to studies conducted by the present inventors, the polyol crosslinking reaction not only allows the fluororubbers (A) to be crosslinked but also allows the compatibilizers (C) to be crosslinked. Namely, in the thermoplastic fluororesin composition of the present embodiment, the compatibilizers (C) may also be partially crosslinked to one another. In this manner, it is possible to suppress forming of lumps at the time of extruding the thermoplastic fluororesin composition and to further improve tensile properties and heat resistance of the thermoplastic fluororesin composition.

<Manufacturing Method of Thermoplastic Fluororesin Composition>

The manufacturing method of the thermoplastic fluororesin composition according to one embodiment of the present invention includes a step of kneading the mixture including the fluororubber (A), the fluororesin (B), the compatibilizer (C) and the polyol crosslinking agent and/or the crosslinking accelerator (D) so as to be dynamically crosslinked.

The fluororesin (B) includes perfluoroalkoxy alkane having a melting point of 280° C. or more and 290° C. or less. The compatibilizer (C) is the terpolymer of tetrafluoroethylene, hexafluoropropylene and vinylidene fluoride. In the terpolymer, the molar ratio of tetrafluoroethylene units to hexafluoropropylene units to vinylidene fluoride units ranges from 30:15:10 to 70:40:50. As a result, the specific gravity of the compatibilizer (C) is approximately 1.90 or more. The weight ratio (%) of the fluororubber (A) to the fluororesin (B) ranges from 20:80 to 60:40. Further, the blending amount of the compatibilizer (C) ranges from 1 to 30 parts by weight with respect to 100 parts by weight of the total between the fluororubber (A) and the fluororesin (B).

For a kneading device for manufacturing the thermoplastic fluororesin composition of the present embodiment, it is possible to adopt a known kneading device including a batch kneader such as a Banbury mixer or a pressure kneader, or a continuous kneader such as a biaxial extruder.

As the manufacturing method of the thermoplastic fluororesin composition according to the first embodiment of the present invention, a case where the composition is manufactured by a pressure kneader with using the fluororesin (B) having a melting point of 285° C. will be described by way of example. In this case, the fluororubber (non-crosslinked fluororubber) (A), the fluororesin (B), the compatibilizer (C), the crosslinking accelerator, the crosslinking accelerator aid (acid receiving agent), a coloring agent and the like are kneaded at a temperature ranging from 290° C. to 310° C. After kneading is performed for 3 to 5 minutes such that a substantially uniform melt is obtained, the polyol crosslinking agent (D) is added, and kneading and crosslinking are performed for another 3 to 5 minutes to obtain a desired thermoplastic fluororesin composition.

As a modification example of the first embodiment, a case where the first fluororesin (B′) having a melting point of 285° C. and the second fluororesin (B″) having a melting point of 270° C. are used as the fluororesin (B) will be described by way of example. In this case, the fluororubber (A), the first fluororesin (B′), the second fluororesin (B″), the compatibilizer (C), the crosslinking accelerator, the crosslinking accelerator aid (acid receiving agent), the coloring agent and the like are kneaded at a temperature ranging from 290° C. to 310° C. After kneading is performed for 3 to 5 minutes such that a substantially uniform melt is obtained, the polyol crosslinking agent (D) is added, and kneading and crosslinking are performed for another 3 to 5 minutes to obtain a desired thermoplastic fluororesin composition.

Note that the kneading order of the fluororubber (A), the fluororesin (B) and the compatibilizer (C) is not limited to a particular order. However, it is preferable that the fluororubber (A) and the compatibilizer (C) are melt-kneaded first, and the fluororesin (B) is added and kneaded thereafter. By doing so, it is possible to suppress thermal decomposition of the fluororubber (A) and the compatibilizer (C) having melting points that are lower than the fluororesin (B) while improving kneading efficiency of the fluororubber (A), the fluororesin (B) and the compatibilizer (C).

A manufacturing method of the thermoplastic fluororesin composition according to the second embodiment of the present invention includes the steps of (a) kneading the mixture including the fluororubber (A), the fluororesin (B), the compatibilizer (C) and the polyol crosslinking agent (D) so as to be dynamically crosslinked, and (b) extruding the product obtained in the step (a) into a tubular shape. In the step (b), a continuous kneader such as a biaxial extruder can be adopted.

The manufacturing method of the thermoplastic fluororesin composition of the second embodiment is a method in which the step (b) is added to the manufacturing method of the first embodiment. The second embodiment includes the step (b) in which the dynamically crosslinked product (hereinafter occasionally referred to as “compound”) obtained in the step (a) is subjected to extrusion molding, whereby the dynamically crosslinked product is oriented in an extended manner, and the fluororesin (B) can easily form the continuous phase in the produced thermoplastic fluororesin composition.

Further, an average diameter of dispersion of the crosslinked fluororubber (A) in the produced thermoplastic fluororesin composition can be set to 5 μm or less.

A manufacturing method of the thermoplastic fluororesin composition according to the third embodiment of the present invention includes the steps of (a) kneading the mixture including the fluororubber (A), the first fluororesin (B′), the compatibilizer (C) and the polyol crosslinking agent (D) so as to be dynamically crosslinked, and (b) mixing the product obtained in the step (a) and the second fluororesin (B″), and extruding the product into a tubular shape. The first fluororesin (B′) is constituted by a fluororesin (such as F1540 and M640 manufactured by Solvay) having a melting point of 275° C. or less. The melting point of the second fluororesin (B″) is not limited to a particular melting point. However, it is preferable that the melting point of the second fluororesin (B″) is higher than the melting point of the first fluororesin (B′).

In the third embodiment, the weight ratio (%) of the fluororubber (A) to a total between the first fluororesin (B′) and the second fluororesin (B″) ranges from 20:80 to 60:40. The weight ratio (%) of the fluororubber (A) to the first fluororesin (B′) ranges from 50:50 to 70:30. The weight ratio (%) of the first fluororesin (B′) to the second fluororesin (B″) ranges from 60:40 to 70:30. Namely, the product obtained in the step (a) has a higher proportion of the crosslinked fluororubber (A) than the final product (thermoplastic fluororesin composition) obtained in the step (b).

In this manner, in the step (a) of the third embodiment, a product (a pellet of the product) (hereinafter referred to as “crosslinking fluororubber masterbatch”) having a higher blending ratio of the fluororubber (A) than the target thermoplastic fluororesin composition is generated beforehand, and then, in the step (b), the second fluororesin (B″) is mixed (dry-blended). By doing so, thermal decomposition of the fluororubber (A) can be minimized, and the thermoplastic fluororesin composition in which the crosslinked fluororubber (A) is in the dispersed phase (island phase) and the first fluororesin (B′) and the second fluororesin (B″) are in the continuous phase (sea phase) can be generated. In addition, the electric wire and the cable having such a thermoplastic fluororesin composition as the covering layer can be obtained.

The third embodiment is particularly effective in that, in a case where a normal fluororesin (melting point: 305° C.) or a fluororesin having a higher melting point (melting point: 313° C.) is used as the second fluororesin (B″) as shown in the examples, the thermoplastic fluororesin composition in which the crosslinked fluororubber (A) is in the dispersed phase (island phase) and the first fluororesin (B′) and the second fluororesin (B″) are in the continuous phase (sea phase) can be generated as in the first and second embodiments.

Note that the phase structure of the product obtained in the step (a) is not limited to a case where the phase structure of the crosslinked fluororubber (A) is in the continuous phase and the phase structure of the first fluororesin (B′) is in the dispersed phase. The phase structures of the crosslinked fluororubber (A) and the fluororesin (B) may both be in the continuous phase. However, in a case where the crosslinked fluororubber (A) is in the continuous phase and the first fluororesin (B′) is in the dispersed phase, and the second fluororesin (B″) is dry-blended and melt-extrusion is performed in a subsequent step, the diameter of dispersion of the crosslinked fluororubber (A) is increased, causing the product to be poor in appearance and having a significantly reduced draw-down capability.

In addition, when the fluororubber (A) is crosslinked by polyol crosslinking as in the step (a), there may be a case where decomposition residue of the crosslinking accelerator such as benzyltriphenylphosphonium chloride remains in the thermoplastic fluororesin composition of the final product. Such a case results in a problem in which volume resistivity of the thermoplastic fluororesin composition is greatly reduced. Thus, it is preferable that the pellets of the crosslinking fluororubber masterbatch which is the product obtained in the step (a) are heated for approximately 1 day at 230° C. to 250° C. The heat treatment allows the decomposition residue to be volatilized, whereby the problem described above can be solved. In addition, the heat treatment allows crosslinking of the fluororubbers (A) in the crosslinking fluororubber masterbatch to further proceed (secondary crosslinking). In this manner, the crosslinking density of the crosslinked fluororubber (A) is increased, and it is effective in that lumps caused by the agglomerates of the crosslinked fluororubber (A) are less likely to form when extruding the thermoplastic fluororesin composition of the final product in the step (b).

<Features and Effects of Thermoplastic Fluororesin Composition>

One of the features of the thermoplastic fluororesin composition according to one embodiment of the present invention is that it includes the fluororubber (A), the fluororesin (B) and the compatibilizer (C), and the fluororesin (B) is constituted by perfluoroalkoxy alkane having a melting point of 280° C. or more and 290° C. or less. In addition, the compatibilizer (C) is the terpolymer of tetrafluoroethylene, hexafluoropropylene and vinylidene fluoride. Further, the fluororubbers (A) are crosslinked to one another in the thermoplastic fluororesin composition by dynamic crosslinking.

Adopting such a configuration in the present embodiment allows the diameter of dispersion of the crosslinked fluororubber (A) to be reduced in the thermoplastic fluororesin composition having the phase structure in which the crosslinked fluororubber (A) is in the dispersed phase (island phase) and the fluororesin (B) is in the continuous phase (sea phase). As a result, it is possible to provide a thermoplastic fluororesin composition having excellent tensile properties and heat resistance capable of resisting high temperatures during continuous operations. Hereinafter, reasons thereof will be described in detail.

The fluororesin (B) constituting the thermoplastic fluororesin composition according to the present embodiment includes perfluoroalkoxy alkane having a melting point of 280° C. or more and 290° C. or less. As described above, the temperature suitable for dynamic crosslinking is 20° C. to 40° C. higher than the melting point of the fluororesin (B) such that kneading of the fluororesin (B) and other raw materials are sufficiently performed. On the other hand, the temperature at which the fluororubber (A) begins to thermally decompose ranges from 300° C. to 310° C. Thus, using the fluororesin (B) having a melting point of 280° C. or more and 290° C. or less satisfies two conditions which are temperature conditions suitable for dynamic crosslinking and temperature conditions in which thermal decomposition of the fluororubber can be suppressed. Namely, it is possible to suppress thermal decomposition of the fluororubber while each of the raw materials is sufficiently kneaded, whereby crosslinking reaction is allowed to sufficiently proceed.

As a result, the fluororubber is crosslinked and cured in the produced thermoplastic fluororesin composition, and the crosslinked fluororubber is completely and uniformly dispersed in the continuous phase (sea phase) of the fluororesin as the dispersed phase (island phase).

Particularly, in a case where the fluororesin (B) is constituted by two types of fluororesins as described in the examples, it was found that the phase structure in which the fluororubber is in the dispersed phase (island phase) and the fluororesin is in the continuous phase (sea phase) can be easily formed and that the thermoplastic fluororesin composition having excellent tensile properties can be easily generated as compared to a case where the fluororesin (B) is constituted by one type of fluororesin.

In addition, in the present embodiment, the terpolymer of tetrafluoroethylene, hexafluoropropylene and vinylidene fluoride is adopted as the compatibilizer (C). The terpolymer is similar to the fluororesin (B) in that it contains tetrafluoroethylene as a monomer unit. In addition, the terpolymer contains vinylidene fluoride as a monomer unit, whereby polarity thereof is similar to that of the fluororubber (A).

In fact, when the molar ratio of vinylidene fluoride units in the terpolymer becomes higher than the molar ratios of tetrafluoroethylene units and hexafluoropropylene units, the terpolymer will have properties as the fluororubber.

Thus, the terpolymer in which the molar ratio of tetrafluoroethylene units is 30% or more and the molar ratio of vinylidene fluoride units is 50% or less is used as the compatibilizer (C), whereby compatibility between the compatibilizer (C) and the fluororubber (A) and compatibility between the compatibilizer (C) and the fluororesin (B) can both be maintained.

Note that the thermoplastic fluororesin composition of the present invention can be subjected to continuous operations at 250° C., although it originally contains a large amount of the fluororubber (A) having a low heat-resistant life of 200° C. For example, even if the thermoplastic fluororesin composition is subjected to continuous operations at 250° C. and the crosslinked fluororubber (A) is thermally deteriorated and is eventually dissipated, the dissipated portions become small gaps since the crosslinked fluororubber (A) is in the dispersed phase, the fluororesin (B) is in the continuous phase and the diameter of dispersion of the crosslinked fluororubber (A) is small, whereby it is considered that the entire thermoplastic fluororesin composition is converted into a fine foam of the fluororesin (B).

Thus, it is considered that the shape of the thermoplastic fluororesin composition is maintained, and tensile properties and flexibility are hardly deteriorated.

(2) Electric Wire

FIG. 1 is a cross-sectional view showing the electric wire (insulated wire) according to one embodiment of the present invention. As shown in FIG. 1, the electric wire 10 according to the present embodiment has a conductor 1, and an insulating layer 2 covering a periphery of the conductor 1. The insulating layer 2 is constituted by the above-described thermoplastic fluororesin composition.

Commonly used metal wires such as a copper wire or a copper alloy wire, as well as an aluminum wire, a gold wire or a silver wire can be used as the conductor 1. In addition, a conductor obtained by plating a metal such as tin or nickel over a periphery of the metal wire may be used as the conductor 1. Further, a twisted conductor in which metal wires are twisted together can be used as the conductor 1.

The electric wire 10 of the present embodiment is manufactured, for example, in the following manner. First, a copper wire is prepared as the conductor 1. Next, the above-described thermoplastic fluororesin composition is extruded by an extruder so as to cover the periphery of the conductor 1, thereby forming the insulating layer 2 having a predetermined thickness. By doing so, the electric wire 10 of the present embodiment can be manufactured.

The thermoplastic fluororesin composition used in the present embodiment is not limited to be used for the electric wire produced in the example, is applicable to any use of any size, and can be used for an insulating layer of each electric wire for an instrument panel wiring, for a vehicle, for an automobile, for an in-device wiring, or for an electric power wiring.

Particularly, the thermoplastic fluororesin composition constituting the insulating layer 2 of the electric wire 10 of the present embodiment has advantages in that it has good tensile properties and flexibility as described above, and can be subjected to continuous operations at 250° C. Thus, the electric wire 10 of the present embodiment can be used as a fluororesin composition-covered electric wire having excellent plasticity and heat resistance.

(3) Cable

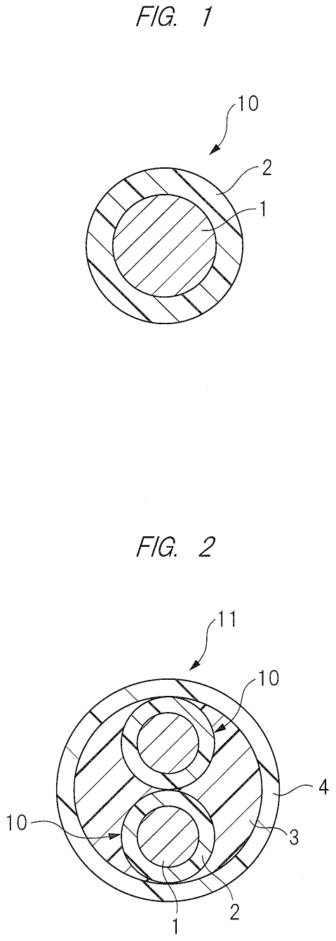

FIG. 2 is a cross-sectional view showing the cable 11 according to one embodiment of the present invention. As shown in FIG. 2, the cable 11 according to the present embodiment comprises a double-strand twisted wire in which two electric wires 10 described above are twisted together, a filler 3 provided over a periphery of the double-strand twisted wire, and a sheath layer 4 provided over a periphery of the filler 3. The sheath layer 4 is constituted by the above-described thermoplastic fluororesin composition.

The cable 11 of the present embodiment is manufactured, for example, in the following manner. First, two electric wires 10 are manufactured by the above-described method. Next, a periphery of the electric wire 10 is covered by the filler 3, and then, the above-described thermoplastic fluororesin composition is extruded so as to cover the filler 3 and form the sheath layer 4 having a predetermined thickness. By doing so, the cable 11 of the present embodiment can be manufactured.

The thermoplastic fluororesin composition constituting the sheath layer 4 of the cable 11 of the present embodiment has advantages in that it has good tensile properties and flexibility as described above, and can be subjected to continuous operations at 250° C. Thus, the cable 11 of the present embodiment can be used as a fluororesin cable having excellent plasticity and heat resistance.

A case where the cable 11 of the present embodiment has a double-strand twisted wire in which two electric wires 10 are twisted together as a core wire has been described by way of example. However, the core wire may be of a single strand (solid core) or may be a multi-strand wire having more than two cores. In addition, a multilayer sheath structure in which another insulating layer (sheath layer) is formed between the electric wire 10 and the sheath layer 4 can be adopted.

Further, a case where the cable 11 of the present embodiment uses the above-described electric wires 10 has been described by way of example. However, the present embodiment is not limited to use such electric wires, and a different electric wire using generic materials can be used.

### EXAMPLES

Hereinafter, the present invention will be further described in detail based on the examples. However, the present invention is not limited to these examples.

### Examples 1 to 8 and Comparative Examples 1 and 2

Hereinafter, Examples 1 to 8 and Comparative Examples 1 and 2 will be described. These examples and comparative examples correspond to the thermoplastic fluororesin composition manufactured by the manufacturing methods of the first and second embodiments.

<Materials of Examples 1 to 8 and Comparative Examples 1 and 2>

The following are materials used for Examples 1 to 8 and Comparative Examples 1 and 2. Table 2 described below shows blending ratios of each of the materials, and the materials were used in such an amount that a total volume was approximately 50 mL.

(A) Fluororubber:
DS246 (Bipolymer of hexafluoropropylene and vinylidene fluoride, made in China, specific gravity: 1.86, Mooney viscosity: 75)

(B) Fluororesin:
(B1) F1540 (Copolymer of trifluoro (trifluoromethoxy) ethylene and tetrafluoroethylene, manufactured by Solvay, MFR (melt-mass flow rate): 8 g to 18 g/10 min, melting point: 270° C.)
(B2) M640 (Copolymer of trifluoro (trifluoromethoxy) ethylene and 1,1,1,2,2,3,3-heptafluoro-3-[(trifluoroethenyl)oxy]propane with tetrafluoroethylene, manufactured by Solvay, MFR: 10 g to 17 g/10 min, melting point: 285° C.)
(B3) AP-210 (Copolymer of trifluoro (trifluoroethoxy) ethylene and tetrafluoroethylene, manufactured by Daikin Industries, MFR: 14 g/10 min, melting point: 305° C.)

(C) Compatibilizer:
(C1) THV-500GZ (Terpolymer of tetrafluoroethylene, hexafluoropropylene and vinylidene fluoride, manufactured by 3M, MFR: 10 g/10 min, melting point: 165° C.)
(C2) THV-221GZ (Terpolymer of tetrafluoroethylene, hexafluoropropylene and vinylidene fluoride, manufactured by 3M, MFR: 20 g/10 min, melting point: 120° C.)

(D) Polyol crosslinking agent:
Curative 30 masterbatch (Mixture of 50% dihydroxy aromatic compound (polyol crosslinking agent) and 50% fluororubber, manufactured by DuPont)

(E) Crosslinking accelerator:
Curative 20 masterbatch (Mixture of 33% benzyltriphenylphosphonium chloride (crosslinking accelerator) and 67% fluororubber, manufactured by DuPont)

(F) Crosslinking accelerator aid (acid receiving agent):
Magnesium oxide (MgO)

Here, details of physical property values of F1540 (B1), M640 (B2), AP-210 (B3), M620 (B4) described below, and P120X (B5) described below which constitute the fluororesin (B) used in the examples are summarized in Table 1.

TABLE 1

| (B) Fluororesin | (B1) F1540 | (B2) M640 | (B3) AP-210 | (B4) M620 | (B5) P120X |
|---|---|---|---|---|---|
| Melting Point (° C.) | 265-275 | 280-290 | 300-310 | 280-290 | 310-316 |
| Weight Ratio (ASTM D792) | 2.11-2.16 | 2.13-2.18 | 2.14-2.16 | 2.13-2.18 | 2.12-2.17 |
| Tensile Strength (MPa) (ASTM D638) | 25 | 21 | 25.5-30.4* | 26 | 26*** |
| Elongation (%) (ASTM D638) | 300 | 280 | 350-450* | 300 | 300*** |
| Hardness (Shore D) (ASTM D2240) | 55-60 | 55-60 | 60-70 | 55-60 | — |
| Tensile Modulus (MPa) (ASTM D638) | 400-500 | 500-600 | 500-600** | 500-600 | 500-600*** |
| Continuous Operation | 225 | 250 | 260 | 250 | 300 |
| Temperature (° C.) (No load) | | | | | |
| MFR (g/10 min) | 8-18 | 10-17 | 10-17 | 2-5 | 2.5-5 |

*Testing method: JIS K 6891
**Testing method: ASTM D895
***Testing method: ASTM D1708

<Configuration of Examples 1 to 8 and Comparative Examples 1 and 2>

Examples 1 to 7 are each examples in which the fluororesin (B) was constituted by two types of fluororesins of F1540 (B1) (melting point: 270° C.) and M640 (B2) (melting point: 285° C.). Examples 1 to 4 are each examples in which THV-500GZ (C1) was used as the compatibilizer (C), the amounts of the fluororubber (A) and the compatibilizer (C) were made to be the same, and ratios of components (B1) and (B2) were changed accordingly.

In addition, Examples 5 to 7 are each examples in which THV-221GZ (C2) was used as the compatibilizer (C), the ratio of the fluororubber (A) to the total of each component was set so as to be substantially constant (see “Ratio of FKM” in Table 2), and ratios of the components (B1) and (B2) and the compatibilizer (C) were changed accordingly.

Example 8 is an example in which the fluororesin (B) was constituted by one type of fluororesin of M640 (B2) (melting point: 285° C.).

Comparative Example 1 is an example in which the fluororesin (B) was constituted by one type of fluororesin of F1540 (B1) (melting point: 270° C.). Comparative Example 2 is an example in which the fluororesin (B) was constituted by one type of fluororesin of AP-210 (B3) (melting point: 305° C.).

Note that, in Examples 1 to 8 and Comparative Examples 1 and 2, the amounts of the polyol crosslinking agent (D), the crosslinking accelerator (E) and the crosslinking accelerator aid (acid receiving agent) (F) are the same.

<Manufacturing Method of Examples 1 to 8 and Comparative Examples 1 and 2>

Samples of Examples 1 to 8 and Comparative Examples 1 and 2 were produced in the following manner. Each of the conditions is given by way of example.

(a) First Kneading Step

Among the blending materials shown in Table 2, components other than the polyol crosslinking agent (Curative 30 masterbatch) (D) and the crosslinking accelerator (Curative 20 masterbatch) (E) were kneaded for 5 minutes at a rotor speed of 60 rpm and a set temperature of 300° C. by using the Labo Plastomill (mixing amount: 60 mL) manufactured by Toyo Seiki Co., Ltd.

(b) Second Kneading Step

After the step (a), it was confirmed that the mixture has become a uniform melt, and then, the crosslinking accelerator (Curative 20 masterbatch) (E) was added and kneaded for 3 minutes under the same conditions.

(c) Third Kneading Step

After the step (b), the polyol crosslinking agent (Curative 30 masterbatch) (D) was added and kneaded for 5 minutes under the same conditions. The sample obtained here will be referred to as “compound”.

(d) Extrusion Step

After the step (c), the compound was heat-treated for 4 hours at 230° C., and then was extruded at a shear rate of 24 sec⁻¹ and at a set temperature of 320° C. by using the E-Melt Indexer manufactured by Toyo Seiki with a die having an outer diameter of 1 mm and a land length of 5 mm. The sample obtained here will be referred to as “extruded capillary strand”.

(e) Pressing Step

After the step (d), the extruded capillary strand was preheated for 2 minutes at 320° C., and then was pressed for 1 minute at a pressure of 10 MPa to obtain a thickness of 1 mm. The sample obtained here will be referred to as “sheet”.

<Evaluation Method of Examples 1 to 8 and Comparative Examples 1 and 2>

(1) Appearance

Appearance of each extruded capillary strand sample was evaluated by visual confirmation and the like. Specifically, samples having a sufficiently smooth surface state were judged as “◯”, samples having a rough surface state were judged as “A”, and samples having a significantly rough surface state were judged as “X”. Those judged as “◯” were designated as “pass”, and those judged as “A” or “X” were designated as “fail”.

(2) Draw-Down Capability

Each extruded capillary strand sample was drawn down so as to have an outer diameter of approximately 0.2 mm, and stability of the appearance and the outer diameter were examined. Samples having passed the stability of both appearance and outer diameter were judged as “◯” (pass), and samples having failed one or the other were judged as “X” (fail)

(3) Thermal Stability

Each extruded capillary strand sample was held in a capillary cylinder of the Melt Indexer for 5 minutes and then was drawn down so as to have an outer diameter of approximately 0.2 mm, and stability of the appearance and outer diameter were examined. Samples having passed the stability of both appearance and outer diameter were judged as “◯” (pass), and samples having failed one or the other were judged as “X” (fail)

(4) Volume Resistivity (Untreated)

Volume resistivity of each sheet sample was measured at room temperature and under atmospheric pressure using a commercially available resistance measuring device.

(5) Volume Resistivity (after Drying)

Each sheet sample was dried for 1 day at 250° C., and then, volume resistivity was measured at room temperature and under atmospheric pressure using the commercially available resistance measuring device.

(6) Hardness (Shore A)

Hardness (Shore A) of each sheet sample was measured by a method compliant to ASTM D2240 and using a type-A durometer.

(7) Phase Structure

Each compound sample and extruded capillary strand sample was observed by using a scanning electron microscope (SEM).

(8) Tensile Properties (Untreated)

Each extruded capillary strand sample was pulled at a tensile speed of 200 mm/min by using a commercially available tensile tester, and tensile strength (maximum stress) (represented by “TS” in Table 2), total elongation (elongation at break) (represented by “TE” in Table 2) and 100% modulus (represented by “100% M” in Table 2) were measured. Here, tensile strength refers to a stress corresponding to a maximum force applied during the test. Total elongation refers to a value of permanent elongation after break expressed in percentages with respect to the original length. 100% modulus refers to a stress at the time where the test sample is extended 100%.

(9) Tensile Properties (after Heating for 30 Days at 280° C.): Heat Resistance

Each extruded capillary strand sample was heated for 30 days at 280° C., and then was pulled at a tensile speed of 200 mm/min by using the commercially available tensile tester, and tensile strength (TS), total elongation (TE) and 100% modulus (100% M) were measured.

<Evaluation Results of Examples 1 to 8 and Comparative Examples 1 and 2>

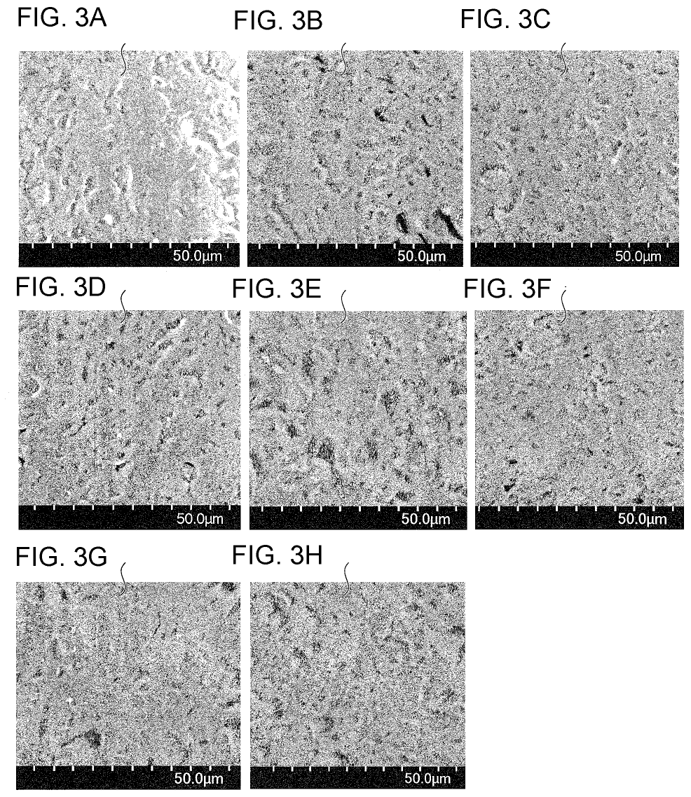

The above measurement results are summarized in Table 2 and FIG. 3. In Table 2, the fluororubber is represented by “FKM”, and the fluororesin is represented by “PFA”.

TABLE 2

| | | Examples | | | | | |
|---|---|---|---|---|---|---|---|
| | | Ex. 1 | Ex. 2 | Ex. 3 | Ex. 4 | Ex. 5 | Ex. 6 |
| (A)FKM | DS246 | 100 | 100 | 100 | 100 | 92 | 75 |
| (B)PFA | (B1)F1540 | 60 | 70 | 80 | 100 | 80 | 60 |
| | (Melting point: 270° C.) | | | | | | |
| | (B2)M640 | 60 | 70 | 80 | 100 | 80 | 60 |
| | (Melting point: 285° C.) | | | | | | |
| | (B3)AP-210 | | | | | | |
| | (Melting point: 305° C.) | | | | | | |
| (C)Compatibilizer | (C1)THV-500GZ | 8 | 8 | 8 | 8 | | |
| | (C2)THV-221GZ | | | | | 16 | 25 |
| (D)Polyol | Curative #30* | 4 | 4 | 4 | 4 | 4 | 4 |
| Crosslinking | | | | | | | |
| Agent | | | | | | | |
| (E)Crosslinking | Curative #20** | 4 | 4 | 4 | 4 | 4 | 4 |
| Accelerator | | | | | | | |
| (F)Crosslinking | MgO | 5 | 5 | 5 | 5 | 5 | 5 |
| Accelerator Aid | | | | | | | |
| Total | | 241 | 261 | 281 | 321 | 281 | 233 |
| Ratio of (A)FKM/All components | | 43.4% | 40.1% | 37.3% | 32.6% | 34.4% | 34.2% |
| Ratio of (B)PFA/All components | | 49.8% | 53.6% | 56.9% | 62.3% | 56.9% | 51.5% |
| Ratio of | | 3.3% | 3.1% | 2.8% | 2.5% | 5.7% | 10.7% |
| (C)Compatibilizer/All components | | | | | | | |
| Ratio of (A)FKM/(A)FKM + (B)PFA | | 46.6% | 42.8% | 39.5% | 34.4% | 37.7% | 39.9% |
| Ratio of (B)PFA/(A)FKM + (B)PFA | | 53.4% | 57.2% | 60.5% | 65.6% | 62.3% | 60.1% |
| Ratio of | | 3.6% | 3.3% | 3.0% | 2.6% | 6.2% | 12.5% |
| (C)Compatibilizer/(A)FKM + (B)PFA | | | | | | | |
| (1)Appearance | | ◯ | ◯ | ◯ | ◯ | ◯ | ◯ |
| (2)Draw-down Capability | | ◯ | ◯ | ◯ | ◯ | ◯ | ◯ |
| (3)Thermal Stability | | ◯ | ◯ | ◯ | ◯ | ◯ | ◯ |
| (4)Volume Resistivity (Ω · cm) (Untreated) | | 3.4E+12 | 5.0E+12 | 6.3E+12 | 7.0E+12 | 4.1E+12 | 5.7E+12 |
| (5)Volume Resistivity(Ω · cm) (After drying) | | 3.8E+15 | 3.2E+15 | 4.2E+15 | 4.8E+15 | 4.2E+15 | 6.0E+15 |
| (6)Hardness (Shore A) | | 94 | 95 | 95 | 97 | 96 | 95 |
| (7)Phase Structure | Compound | Sea-Sea | Sea-Sea | Sea-Isl. | Sea-Isl. | Sea-Isl. | Sea-Isl. |
| | Extruded Capillary | Sea-Isl. | Sea-Isl. | Sea-Isl. | Sea-Isl. | Sea-Isl. | Sea-Isl. |
| | Strand | | | | | | |
| (8)Tensile | TS (MPa) | 13.1 | 12.8 | 13.0 | 14.8 | 13.9 | 15.0 |
| Properties | TE (%) | 400 | 360 | 350 | 350 | 420 | 400 |
| (Untreated) | 100% M (MPa) | 6.9 | 7.2 | 7.8 | 8.6 | 7.4 | 7.5 |
| (9)Tensile | TS (MPa) | 13.6 | 12.6 | 12.8 | 15.2 | 13.2 | 14.2 |
| Properties | TE (%) | 340 | 320 | 320 | 330 | 360 | 320 |
| (After heating) | 100% M (MPa) | 7.2 | 7.6 | 8.2 | 8.8 | 7.8 | 7.6 |

| | | Examples | | | |
|---|---|---|---|---|---|
| | | | | Compar. | Compar. |
| | | Ex. 7 | Ex. 8 | Ex. 1 | Ex. 2 |
| (A)FKM | DS246 | 68 | 92 | 100 | 100 |
| (B)PFA | (B1)F1540 | 50 | | 140 | |
| | (Melting point: 270° C.) | | | | |
| | (B2)M640 | 50 | 160 | | |
| | (Melting point: 285° C.) | | | | |
| | (B3)AP-210 | | | | 200 |
| | (Melting point: 305° C.) | | | | |
| (C)Compatibilizer | (C1)THV-500GZ | | | 8 | 8 |
| | (C2)THV-221GZ | 32 | 16 | | |
| (D)Polyol | Curative #30* | 4 | 4 | 4 | 4 |
| Crosslinking | | | | | |
| Agent | | | | | |
| (E)Crosslinking | Curative #20** | 4 | 4 | 4 | 4 |
| Accelerator | | | | | |
| (F)Crosslinking | MgO | 5 | 5 | 5 | 5 |
| Accelerator Aid | | | | | |
| Total | | 213 | 281 | 261 | 321 |
| Ratio of (A)FKM/All components | | 34.1% | 34.4% | 40.1% | 32.6% |
| Ratio of (B)PFA/All components | | 46.9% | 56.9% | 53.6% | 62.3% |
| Ratio of | | 15.0% | 5.7% | 3.1% | 2.5% |
| (C)Compatibilizer/All components | | | | | |
| Ratio of (A)FKM/(A)FKM + (B)PFA | | 42.1% | 37.7% | 42.8% | 34.4% |
| Ratio of (B)PFA/(A)FKM + (B)PFA | | 57.9% | 62.3% | 57.2% | 65.6% |
| Ratio of | | 18.5% | 6.2% | 3.3% | 2.6% |
| (C)Compatibilizer/(A)FKM + (B)PFA | | | | | |
| (1)Appearance | | ◯ | ◯ | Δ | X (340° C.) |
| (2)Draw-down Capability | | ◯ | ◯ | X | X (340° C.) |
| (3)Thermal Stability | | ◯ | ◯ | — | — |
| (4)Volume Resistivity (Ω · cm) (Untreated) | | 6.2E+12 | 6.1E+12 | 3.4E+12 | — |
| (5)Volume Resistivity(Ω · cm) (After drying) | | 7.0E+15 | 7.3E+15 | 3.8E+15 | — |
| (6)Hardness (Shore A) | | 94 | 96 | 94 | — |
| (7)Phase Structure | Compound | Sea-Isl. | Sea-Isl. | Sea-Sea | — |
| | Extruded Capillary | Sea-Isl. | Sea-Isl. | Sea-Sea | — |
| | Strand | | | | |
| (8)Tensile | TS (MPa) | 14.2 | 11.7 | 7.1 | — |
| Properties | TE (%) | 390 | 360 | 240 | — |
| (Untreated) | 100% M (MPa) | 6.9 | 7.5 | 7.1 | — |
| (9)Tensile | TS (MPa) | 13.8 | 10.5 | 5.8 | — |
| Properties | TE (%) | 320 | 320 | 40 | — |
| (After heating) | 100% M (MPa) | 7.3 | 7.8 | — | — |

*Includes 50% of (A)FKM components
**Includes 67% of (A)FKM components

As shown in Table 2, Examples 1 to 8 exhibited good values for (1) appearance, (2) draw-down capability, (3) thermal stability, (6) hardness, (8) tensile properties (untreated) and (9) tensile properties (after heating). In addition, Examples 1 to 8 failed to exhibit good values for (4) volume resistivity (untreated), but exhibited good values for (5) volume resistivity (after drying) in which the samples where dried for 1 day at 250° C.

Although not shown, the (7) phase structure of each compound sample of Example 1 (region a) and Example 2 (region b) was a sea-sea structure, that is, the structure in which the crosslinked fluororubber (A) and the fluororesin (B) are both in the continuous phase. On the other hand, as shown in FIG. 3, the (7) phase structure of each extruded capillary strand sample of Example 1 (region a) and Example 2 (region b) was the sea-island structure, that is, the structure in which the fluororesin (B) is in the continuous phase and the crosslinked fluororubber (A) is in the dispersed phase. In addition, each diameter of dispersion of the crosslinked fluororubber (A) in Example 1 (region a) and Example 2 (region b) was as small as approximately 5 μm.

On the other hand, although not shown, the (7) phase structure of each compound sample of Examples 3 to 8 (regions c to h) was the sea-island structure, that is, the structure in which the fluororesin (B) is in the continuous phase and the crosslinked fluororubber (A) is in the dispersed phase. Further, as shown in FIG. 3, the (7) phase structure of each extruded capillary strand sample of Examples 3 to 8 (regions c to h) was the sea-island structure, that is, the structure in which the fluororesin (B) is in the continuous phase and the crosslinked fluororubber (A) is in the dispersed phase. In addition, the diameter of dispersion of the crosslinked fluororubber (A) in Examples 3 to 8 (regions c to h in FIG. 3) was as small as approximately 5 μm.

In addition, as shown in Table 2, values of (3) thermal stability, (4) volume resistivity (untreated), (5) volume resistivity (after drying) and (6) hardness of Comparative Example 1 were almost the same as those of Examples 1 to 8. On the other hand, (1) appearance and (2) draw-down capability of Comparative Examples 1 and 2 were poor. The (8) tensile properties (untreated) and (9) tensile properties (after heating) of Comparative Example 1 were also poor.

In addition, the (7) phase structure of the compound sample and extruded capillary strand sample of Comparative Example 1 was the sea-sea structure, that is, the structure in which the crosslinked fluororubber (A) and the fluororesin (B) are both in the continuous phase.

### Examples 9 to 14

Hereinafter, Examples 9 to 14 will be described. These examples correspond to the thermoplastic fluororesin composition manufactured by the manufacturing method of the third embodiment. Namely, Examples 9 to 14 were each produced by producing the above-described crosslinking fluororubber masterbatch (hereinafter referred to as “crosslinking fluororubber masterbatch” 1 to 4), and then dry-blending the crosslinking fluororubber masterbatch and the fluororesin.

<Materials of Examples 9 to 14>

The following are materials used for Examples 9 to 14 that differ from the materials of Examples 1 to 8 and Comparative Examples 1 and 2.

(B) Fluororesin:
(B4) M620 (Copolymer of trifluoro (trifluoromethoxy) ethylene and 1,1,1,2,2,3,3-heptafluoro-3-[(trifluoroethenyl)oxy]propane with tetrafluoroethylene, manufactured by Solvay, MFR: 2 g to 5 g/10 min, melting point: 285° C.)
(B5) P120X (Copolymer of trifluoro (trifluoroethoxy) ethylene and tetrafluoroethylene, manufactured by Solvay, MFR: 2.5 g to 5 g/10 min, melting point: 313° C.)

Other materials used in Examples 9 to 14 are the same as those used in Examples 1 to 8 and Comparative Examples 1 and 2, and thus, descriptions thereof will be omitted.

Details of the crosslinking fluororubber masterbatches 1 to 4 used in Examples 9 to 14 are summarized in Table 3. Tables 3 and 4 described below show blending ratios of each of the materials, and the materials were used in such an amount that the total volume was approximately 50 mL.

TABLE 3

| Crosslinking Fluororubber Masterbatches | | MB1 | MB2 | MB3 | MB4 |
|---|---|---|---|---|---|
| (A) FKM | DS246 | 100 | 100 | 100 | 100 |
| (B) PFA | (B1) F1540 | 140 | 140 | | 70 |
| | (Melting point: 270° C.) | | | | |
| | (B2) M640 | | | 140 | 70 |
| | (Melting point: 285° C.) | | | | |
| (C) Compatibilizer | (C1) THV-500GZ | 8 | 8 | 8 | 8 |
| (D) Polyol | Curative #30* | 4 | 5.2 | 4 | 4 |
| Crosslinking | | | | | |
| Agent | | | | | |
| (E) Crosslinking | Curative #20** | 4 | 5.2 | 4 | 4 |
| Accelerator | | | | | |
| (F) Crosslinking | MgO | 5 | 5 | 5 | 5 |
| Accelerator Aid | | | | | |

| | | | | |
|---|---|---|---|---|
| Total | 261 | 263.4 | 261 | 261 |
| Ratio of (A) FKM/All components | 40.1% | 40.3% | 40.1% | 40.1% |
| Ratio of (B) PFA/All components | 53.6% | 53.2% | 53.6% | 53.6% |
| Ratio of (C) Compatibilizer/All components | 3.1% | 3.0% | 3.1% | 3.1% |
| Ratio of (A) FKM/(A) FKM + (B) PFA | 42.8% | 43.1% | 42.8% | 42.8% |
| Ratio of (B) PFA/(A) FKM + (B) PFA | 57.2% | 56.9% | 57.2% | 57.2% |
| Ratio of (C) Compatibilizer/(A) FKM + (B) PFA | 3.3% | 3.3% | 3.3% | 3.3% |
| Set Temperature (° C.) | 290-300 | 290 | 305 | 300 |
| Rotor Speed (rpm) | 60 | 60 | 60 | 60 |

*Includes 50% of (A) FKM components
**Includes 67% of (A) FKM components

<Producing Crosslinking Fluororubber Masterbatch 1 to be Used in Examples 9 to 14>

The crosslinking fluororubber masterbatch 1 to be used in Examples 9 to 14 was produced in the following manner. Each of the conditions is given by way of example.

(f) First Kneading Step

Among the blending materials shown in Table 3, components other than the polyol crosslinking agent (Curative 30 masterbatch) (D) and the crosslinking accelerator (Curative 20 masterbatch) (E) were kneaded for 5 minutes at a rotor speed of 60 rpm and a set temperature ranging from 290° C. to 300° C. by using the Labo Plastomill (mixing amount: 60 mL) manufactured by Toyo Seiki Co., Ltd.

(g) Second Kneading Step

After the step (f), it was confirmed that the mixture has become a uniform melt, and then, the crosslinking accelerator (Curative 20 masterbatch) (E) was added and kneaded for 3 minutes under the same conditions.

(h) Third Kneading Step

After the step (g), the polyol crosslinking agent (Curative 30 masterbatch) (D) was added and kneaded for 6 minutes under the same conditions. Next, the kneaded product was pelletized to obtain a masterbatch. The masterbatch obtained here will be referred to as “crosslinking fluororubber masterbatch 1 (MB1)”

<Producing Crosslinking Fluororubber Masterbatch 2 to be Used in Examples 9 to 14>

As shown in Table 3, conditions for producing the crosslinking fluororubber masterbatch 2 are the same as those of the crosslinking fluororubber masterbatch 1, with the exception that the amounts of the polyol crosslinking agent (Curative 30 masterbatch) (D) and the crosslinking accelerator (Curative 20 masterbatch) (E) have each been increased by 30%. The masterbatch obtained here will be referred to as “crosslinking fluororubber masterbatch 2 (MB2)”.

<Producing Crosslinking Fluororubber Masterbatch 3 to be Used in Examples 9 to 14>

As shown in Table 3, conditions for producing the crosslinking fluororubber masterbatch 3 are the same as those of the crosslinking fluororubber masterbatch 1, with the exception that the fluororesin (B) was changed from F1540 (B1) (melting point: 270° C.) to M640 (B2) (melting point: 285° C.) and that the set temperature at the time of kneading was set to 305° C.

The masterbatch obtained here will be referred to as “crosslinking fluororubber masterbatch 3 (MB3)”.

<Producing Crosslinking Fluororubber Masterbatch 4 to be Used in Examples 9 to 14>

As shown in Table 3, conditions for producing the crosslinking fluororubber masterbatch 4 are the same as those of the crosslinking fluororubber masterbatch 1, with the exception that the fluororesin (B) was changed from F1540 (B1) (melting point: 270° C.) to a mixture of F1540 (B1) (melting point: 270° C.) and M640 (B2) (melting point: 285° C.) and that the set temperature at the time of kneading was set to 300° C.

The masterbatch obtained here will be referred to as “crosslinking fluororubber masterbatch 4 (MB4)”.

<Manufacturing Method of Examples 9 to 14>

Samples of Examples 9 to 14 were produced in the following manner. Each of the conditions is given by way of example.

(i) Fourth Kneading Step

The fluororesin (B) was added to the crosslinking fluororubber masterbatch 1, 2 or 3, and was kneaded for 5 minutes at a rotor speed of 40 rpm and a set temperature of 320° C. by using a mixer (mixing amount: 60 mL). The sample obtained here will be referred to as “compound”.

(j) Extrusion Step

After the step (i), the compound was extruded at a shear rate of 20 sec⁻¹ and at a set temperature of 320° C. by using a capilograph with a die having an outer diameter of 2.095 mm and a land length of 8 mm. The sample obtained here will be referred to as “extruded capillary strand”.

(k) Pressing Step

After the step (j), the extruded capillary strand was preheated for 2 minutes at 320° C., and then was pressed for 1 minute at a pressure of 10 MPa to obtain a thickness of 1 mm. The sample obtained here will be referred to as “sheet”.

<Configuration of Examples 9 to 14>

Examples 9 to 14 are each examples in which the product (crosslinking fluororubber masterbatch) having a higher blending ratio of the fluororubber (A) than the target thermoplastic fluororesin composition was produced in advance, and then, the fluororesin (B) was further mixed (dry-blended). Examples 9 to 11 are each examples in which the fluororesin (B) contained in the crosslinking fluororubber masterbatch was F1540 (B1) (melting point: 270° C.) and the fluororesin (B) added thereafter was M620 (B4) (melting point: 285° C.), resulting in the thermoplastic fluororesin composition constituted by two types of fluororesins.

Examples 9 and 10 are each examples in which the amounts of the polyol crosslinking agent (Curative 30 masterbatch) (D) and the crosslinking accelerator (Curative 20 masterbatch) (E) were changed by changing the type of crosslinking fluororubber masterbatch. Examples 9 and 11 are each examples in which the ratio of the crosslinking fluororubber masterbatch to the fluororesin (B) to be added later was changed.

Example 12 is an example in which the fluororesin (B) contained in the crosslinking fluororubber masterbatch and the fluororesin (B) to be added later were both M640 (B2) (melting point: 285° C.), resulting in the thermoplastic fluororesin composition substantially constituted by one type of fluororesin.

Example 13 is an example in which the fluororesin (B) contained in the crosslinking fluororubber masterbatch was F1540 (B1) (melting point: 270° C.) and the fluororesin (B) to be added later was AP-210 (B3) (melting point: 305° C.), resulting in the thermoplastic fluororesin composition constituted by two types of fluororesins.

Example 14 is an example in which the fluororesin (B) contained in the crosslinking fluororubber masterbatch was the mixture of F1540 (B1) (melting point: 270° C.) and M640 (B2) (melting point: 285° C.), and the fluororesin (B) to be added later was P120X (B5) (melting point: 313° C.), resulting in the thermoplastic fluororesin composition constituted by two types of fluororesins.

Note that, in Examples 9 to 14, the amounts of the compatibilizer (C) and the crosslinking accelerator aid (acid receiving agent) (F) are the same.

<Evaluation Method of Examples 9 to 14>

The evaluation method of Examples 9 to 14 is the same as that of Examples 1 to 8 and Comparative Examples 1 and 2, and thus, descriptions thereof will be omitted.

<Evaluation Results of Examples 9 to 14>

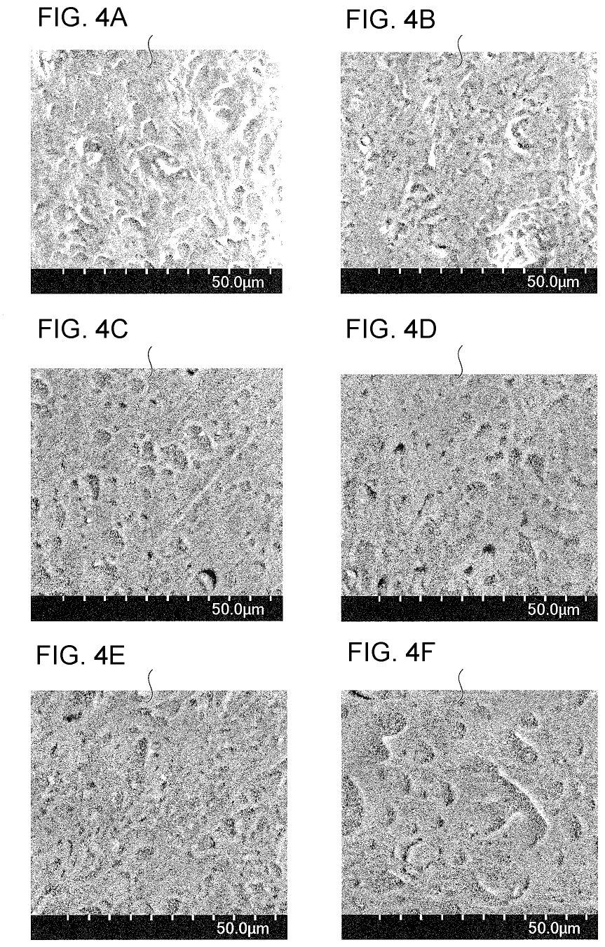

The above measurement results are summarized in FIG. 4 and Table 4. In Table 4, the fluororubber is represented by “FKM” and the fluororesin is represented by “PFA”.

TABLE 4

| | | Examples | | | | | |
|---|---|---|---|---|---|---|---|
| | | Ex. 9 | Ex. 10 | Ex. 11 | Ex. 12 | Ex. 13 | Ex. 14 |
| Crosslinking | MB1 | 80 | | 67 | | 80 | |
| Fluororubber | MB2 | | 80 | | | | |
| Masterbatch | MB3 | | | | 80 | | |
| | MB4 | | | | | | 80 |
| (B)PFA | (B2)M640 | | | | 20 | | |
| | (Melting point: 285° C.) | | | | | | |
| | (B4)M620 | 20 | 20 | 33 | | | |
| | (Melting point: 285° C.) | | | | | | |
| | (B3)AP-210 | | | | | 20 | |
| | (Melting point: 305° C.) | | | | | | |
| | (B5)P120X | | | | | | 20 |
| | (Melting point: 313° C.) | | | | | | |
| Total | | 100 | 100 | 100 | 100 | 100 | 100 |
| Ratio of (A)FKM/All components | | 32.1% | 32.2% | 26.9% | 32.1% | 32.1% | 32.1% |
| Ratio of (B)PFA/All components | | 62.9% | 62.5% | 68.9% | 62.9% | 62.9% | 62.9% |
| Ratio of | | 2.5% | 2.4% | 2.1% | 2.5% | 2.5% | 2.5% |
| (C)Compatibilizer/All components | | | | | | | |
| Ratio of (A)FKM/(A)FKM + (B)PFA | | 33.8% | 34.0% | 28.0% | 33.8% | 33.8% | 33.8% |
| Ratio of (B)PFA/(A)FKM + (B)PFA | | 66.2% | 66.0% | 72.0% | 66.2% | 66.2% | 66.2% |
| Ratio of | | 2.6% | 2.6% | 2.1% | 2.6% | 2.6% | 2.6% |
| (C)Compatibilizer/(A)FKM + (B)PFA | | | | | | | |
| (1)Appearance | | ◯ | ◯ | ◯ | ◯ | ◯ | ◯ |
| (2)Draw-down Capability | | ◯ | ◯ | ◯ | ◯ | ◯ | ◯ |
| (3)Thermal Stability | | ◯ | ◯ | ◯ | ◯ | ◯ | ◯ |
| (4)Volume Resistivity(Ω · cm) (Untreated) | | 2.5E+13 | 6.2E+13 | 4.8E+13 | 4.7E+13 | 4.2E+15 | 3.6E+15 |
| (5)Volume Resistivity(Ω · cm) (After drying) | | 4.2E+15 | 3.6E+15 | 4.7E+15 | 5.1E+15 | — | — |
| (6)Hardness(Shore A) | | 96 | 96 | 97 | 97 | 96 | 96 |
| (7)Phase Structure | Compound | Sea-Sea | Sea-Isl. | Sea-Isl. | Sea-Isl. | Sea-Isl. | Sea-Isl. |
| | Extruded Capillary | Sea-Isl. | Sea-Isl. | Sea-Isl. | Sea-Isl. | Sea-Isl. | Sea-Isl. |
| | Strand | | | | | | |
| (8)Tensile | TS (MPa) | 15.8 | 16.2 | 21.8 | 13.6 | 16.4 | 15.3 |
| Properties | TE (%) | 350 | 340 | 400 | 380 | 380 | 390 |
| (Untreated) | 100% M (MPa) | 9.1 | 9.3 | 10.1 | 8.8 | 8.9 | 8.6 |
| (9)Tensile | TS (MPa) | 13.6 | 14.8 | 17.7 | 11.4 | 16.8 | 16 |
| Properties | TE (%) | 310 | 320 | 340 | 330 | 370 | 370 |
| (After heating) | 100% M (MPa) | 9.6 | 9.6 | 11.3 | 9.1 | 9.2 | 8.8 |

As shown in Table 4, Examples 9 to 14 exhibited good values for (1) appearance, (2) draw-down capability, (3) thermal stability, (6) hardness, (8) tensile properties (untreated) and (9) tensile properties (after heating). In addition, Examples 9 to 14 exhibited good values for the (4) volume resistivity (untreated) in which the values were higher by one order of magnitude than those of Examples 1 to 8. The examples exhibited good values for (5) volume resistivity (after drying) in which the values were almost the same as those of Examples 1 to 8.

Although not shown, the (7) phase structure of the compound sample of Example 9 was the sea-sea structure, that is, the structure in which the crosslinked fluororubber (A) and the fluororesin (B) are both in the continuous phase. On the other hand, as shown in FIG. 4, the (7) phase structure of the extruded capillary strand sample of Example 9 was the sea-island structure, that is, the structure in which the fluororesin (B) is in the continuous phase and the crosslinked fluororubber (A) is in the dispersed phase.

Further, although not shown, the (7) phase structure of each compound sample of Examples 10 to 14 was the sea-island structure, that is, the structure in which the fluororesin (B) is in the continuous phase and the crosslinked fluororubber (A) is in the dispersed phase. Furthermore, as shown in FIG. 4, the (7) phase structure of each extruded capillary strand sample of Examples 10 to 14 was the sea-island structure, that is, the structure in which the fluororesin (B) is in the continuous phase and the crosslinked fluororubber (A) is in the dispersed phase.

### Example 15

Hereinafter, Example 15 will be described. The example corresponds to the electric wire 10 shown in FIG. 1.

<Materials of Example 15>

In Example 15, a nickel-plated twisted conductor having a cross-sectional area of 2 mm² is used as the conductor 1 shown in FIG. 1. In addition, as shown in Table 5, the thermoplastic fluororesin composition having the same composition as that of Example 11 (see Table 4) is used as the insulating layer 2.

<Manufacturing Method of Example 15>

A sample of Example 15 was produced in the following manner. Each of the conditions is given by way of example.

The crosslinking fluororubber masterbatch 1 was pulverized to a size of 1 millimeter square or less, and pellets of M620 (B4) (melting point: 285° C.) as the fluororesin (B) were added and dry-blended. Next, the nickel-plated twisted conductor was inserted through a die of a 20 mm single-shaft extruder. Next, the dry-blended mixed pellets were fed from a hopper of the 20 mm single-shaft extruder, the thermoplastic fluororesin composition was extruded into a tubular shape and drawn down while pulling into a vacuum, and an insulating layer having a thickness of 0.3 mm was formed over a periphery of the nickel-plated twisted conductor so as to produce the electric wire.

Note that a ratio L/D of a screw diameter D to a screw length L was set to 25. In addition, temperatures of the four cylinders were respectively set to 200° C., 300° C., 320° C. and 320° C. from a side of the hopper, and a temperature of a head was set to 320° C. Further, rotation speed of the screw was set to 20 rpm. The die had a diameter of 10 mm with a land length of 5 mm, and a nipple had a diameter of 7 mm with a land length of 10 mm.

<Evaluation Method of Example 15>

The evaluation method of Example 15 is the same as that of Examples 1 to 14 and Comparative Examples 1 and 2, and thus, descriptions thereof will be omitted. However, evaluation items have been set as follows: (1) appearance, (2) volume resistivity (after drying), (3) hardness (Shore A), (4) phase structure, (5) tensile properties (untreated), and (6) tensile properties (after heating for 30 days at 280° C.): heat resistance.

Further, (4) phase structure, (5) tensile properties (untreated) and (6) tensile properties (after heating) were measured after the conductor was pulled out from the produced electric wire such that only the insulating layer was present. In addition, this insulating layer was preheated for 2 minutes at 320° C., then was pressed for 1 minute at a pressure of 10 MPa to obtain a “sheet” having a thickness of 1 mm, and (2) volume resistivity (after drying) and (3) hardness (Shore A) were measured.

<Evaluation Results of Example 15>

The above measurement results are summarized in Table 5. In Table 5, the fluororubber is represented by “FKM” and the fluororesin is represented by “PFA”.

TABLE 5

| Example | | Ex. 15 |
|---|---|---|
| Crosslinking | MB1 | 67 |
| Fluororubber | | |
| Masterbatch | | |
| (B) PFA | (B4) M620 | 33 |
| | (Melting point: 285° C.) | |
| Total | | 100 |
| Ratio of (A) FKM/All components | | 26.9% |
| Ratio of (B) PFA/All components | | 68.9% |
| Ratio of (C) Compatibilizer/All components | | 2.1% |
| Ratio of (A) FKM/(A) FKM + (B) PFA | | 28.0% |
| Ratio of (B) PFA/(A) FKM + (B) PFA | | 72.0% |
| Ratio of (C) Compatibilizer/(A) FKM + (B) PFA | | 2.1% |
| (1) Appearance | | ◯ |
| (2) Volume Resistivity (Ω · cm) (After drying) | | 5.2E+15 |
| (3) Hardness (Shore A) | | 97 |
| (4) Phase Structure | | Sea-Isl. |
| (5) Tensile | TS (MPa) | 21.5 |
| Properties | TE (%) | 400 |
| (Untreated) | 100% M (MPa) | 10.4 |
| (6) Tensile | TS (MPa) | 19.5 |
| Properties | TE (%) | 350 |
| (After heating) | 100% M (MPa) | 10.2 |

As shown in Table 5, Example 15 exhibited good values for (1) appearance, (2) volume resistivity (after drying), (3) hardness, (5) tensile properties (untreated) and (6) tensile properties (after heating). In addition, although not shown, the (7) phase structure of Example 15 was the sea-island structure, that is, the structure in which the fluororesin (B) is in the continuous phase and the crosslinked fluororubber (A) is in the dispersed phase.

(Summary of Examples)

Comparison between Example 8 and Comparative Examples 1 and 2 that include fluororesins (B) having different melting points revealed that, when the fluororesin (B) constituting the thermoplastic fluororesin composition has a melting point of 280° C. or more and 290° C. or less, the thermoplastic fluororesin composition exhibits excellent tensile properties and heat resistance.

In addition, comparison between Example 2 and Comparative Example 1 revealed that, when the thermoplastic fluororesin composition contains two types of fluororesins (B) having different melting points, or more specifically, when one of the two types of fluororesins (B) has a melting point of 280° C. or more and 290° C. or less, the thermoplastic fluororesin composition exhibits tensile properties and heat resistance.

Particularly, comparison between Examples 1 to 4, 9, 11 and 12 and Comparative Example 1 revealed that, when the ratio of the fluororesin (B) having a melting point of 280° C. or more and 290° C. or less is increased, the sea-island structure, that is, the phase structure in which the fluororubber is in the dispersed phase (island phase) and the fluororesin is in the continuous phase (sea phase), is easily obtained.

In addition, comparison between Examples 1, 2, and 5 to 7 revealed that, when the ratio of the compatibilizer (C) is increased, the sea-island structure, that is, the phase structure in which the fluororubber is in the dispersed phase (island phase) and the fluororesin is in the continuous phase (sea phase), is easily obtained even if the ratio of the fluororesin (B) is low.

In addition, comparison between Examples 9 and 10 revealed that, when the amounts of the polyol crosslinking agent (D) and the crosslinking accelerator (E) are increased, the sea-island structure, that is, the phase structure in which the fluororubber is in the dispersed phase (island phase) and the fluororesin is in the continuous phase (sea phase), is easily obtained.

In addition, comparison between each compound sample and extruded capillary strand sample of Examples 1, 2 and 9 revealed that the extruded strand sample is more likely to have the sea-island structure, that is, the phase structure in which the fluororubber is in the dispersed phase (island phase) and the fluororesin is in the continuous phase (sea phase). It is believed that extruding the dynamically crosslinked product (compound) allows the dynamically crosslinked product to be oriented in an extended manner.

In addition, comparison between Examples 13, 14 and Comparative Example 2 revealed that, even in a case where the fluororesin (B) having a high melting point of 290° C. or more is used, when this fluororesin having the high melting point is dynamically crosslinked and then is dry-blended, the thermoplastic fluororesin composition in which the fluororubber is in the dispersed phase (island phase) and the fluororesin is in the continuous phase (sea phase) can be generated.

The present invention is not to be limited to the foregoing embodiments and examples, and various modifications and alterations can be made without departing from the scope of the present invention.

Hereinafter, other items corresponding to the contents of the foregoing embodiments or some of the contents thereof will be described.

[Additional Statement 1]

A manufacturing method of a thermoplastic fluororesin composition, having the steps of:

(a) kneading a mixture including a fluororubber, a fluororesin, a compatibilizer and a polyol crosslinking agent so as to be dynamically crosslinked; and

(b) extruding the product obtained in the step (a) into a tubular shape,

wherein the fluororesin includes a first fluororesin constituted by perfluoroalkoxy alkane having a melting point of 280° C. or more and 290° C. or less, and the compatibilizer is a terpolymer of tetrafluoroethylene, hexafluoropropylene and vinylidene fluoride.

[Additional Statement 2]

The manufacturing method of a thermoplastic fluororesin composition according to Additional Statement 1,

wherein a weight ratio (%) of the fluororubber to the fluororesin ranges from 20:80 to 60:40.

[Additional Statement 3]

The manufacturing method of a thermoplastic fluororesin composition according to Additional Statement 2,

wherein the fluororesin further includes a second fluororesin having a melting point of 275° C. or less.

[Additional Statement 4]

The manufacturing method of a thermoplastic fluororesin composition according to Additional Statement 3,

wherein the compatibilizer is the terpolymer of tetrafluoroethylene, hexafluoropropylene and vinylidene fluoride in which a molar ratio of tetrafluoroethylene units to hexafluoropropylene units to vinylidene fluoride units ranges from 30:15:10 to 70:40:50.

[Additional Statement 5]

A manufacturing method of a thermoplastic fluororesin composition, having the steps of:

(a) kneading a mixture including a fluororubber, a first fluororesin, a compatibilizer and a polyol crosslinking agent so as to be dynamically crosslinked; and

(b) mixing the product obtained in the step (a) and a second fluororesin and extruding the product into a tubular shape,

wherein the first fluororesin is constituted by perfluoroalkoxy alkane having a melting point of 290° C. or less,

a melting point of the second fluororesin is higher than that of the first fluororesin, and

the compatibilizer is a terpolymer of tetrafluoroethylene, hexafluoropropylene and vinylidene fluoride.

What is claimed is:

1. A thermoplastic fluororesin composition comprising a fluororubber, a fluororesin, and a compatibilizer,
wherein the fluororesin includes a first fluororesin constituted by perfluoroalkoxy alkane having a melting point of 280° C. or more and 290° C. or less,
the compatibilizer is a terpolymer of tetrafluoroethylene, hexafluoropropylene and vinylidene fluoride,
a weight ratio (%) of the fluororubber to the fluororesin ranges from 20:80 to 60:40, and
the fluororubbers are crosslinked to one another by dynamic crosslinking.

2. The thermoplastic fluororesin composition according to claim 1,
wherein the compatibilizer is the terpolymer of tetrafluoroethylene, hexafluoropropylene and vinylidene fluoride in which a molar ratio of tetrafluoroethylene units to hexafluoropropylene units to vinylidene fluoride units ranges from 30:15:10 to 70:40:50.

3. The thermoplastic fluororesin composition according to claim 1,
wherein the fluororesin further includes a second fluororesin having a melting point of 275° C. or less.

4. An electric wire comprising an insulating layer made of the thermoplastic fluororesin composition according to claim 1.

5. A cable comprising a sheath layer made of the thermoplastic fluororesin composition according to claim 1.
